(19) United States
(12) Patent Application Publication
(10) Pub. No.: US 2004/0179448 A1
(43) Pub. Date: Sep. 16, 2004

(54) OPU burnout protection circuit and optical drive utilizing the same

(76) Inventors: Yao-Cheng Huang, Taipei City (TW); Hsing-Hua Liu, Pingjhen City (TW); Lin Hsiao, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/793,405

(22) Filed: Mar. 4, 2004

(30) Foreign Application Priority Data
Mar. 10, 2003 (TW) 92105084

(51) Int. Cl. G11B 7/00

(52) U.S. Cl. 369/53.18

(57) ABSTRACT

An OPU burnout protection circuit and a optical drive utilizing the same. The OPU burnout protection circuit monitors power status of an OPU driver of the optical drive to prevent burnout of an OPU when an application specific integrated circuit (ASIC) chip or central processing unit (CPU) chip malfunctions.

### BACKGROUND OF THE INVENTION

1. Field of the Invention

The present invention relates to an optical drive, and in particular to an optical pickup unit (OPU) burnout protection circuit and an optical drive utilizing the same.

2. Description of the Related Art

When fabricating an optical drive, i.e. a CD-ROM, CD-RW, DVD-RW, burnout of an optical pickup unit (OPU) thereof due to failure or malfunction of an application specific integrated circuit (ASIC) chip or central processing unit (CPU) chip is a common problem. Unlike a computer crash, wherein damage to internal components can be prevented by a simple restart, burnout of the OPU in the optical drive is unrecoverable. The OPU has an acrylic rather than glass optical lens. When an optical drive malfunctions continuously, large current passes through coils of an actuator, thus overheating the coils.

As shown in FIG. 1, Focus+, Focus−, Track+, and Track− are pins of an OPU driver 1 for controlling an OPU 100 to move upward, downward, leftward, and rightward for reading or writing data on a compact disc. Coils are coupled with the pins near the OPU 100. When an optical drive malfunctions, large current flows through the coils generating excessive heat therein. The continuous heat alters the chemical properties of the coils and internal resistance thereof. Additionally, the overheated coils affect the actuator causing the acrylic optical lens of the OPU 100 to melt.

Currently, an ASIC chip has neither a protection mechanism nor detection function. Therefore, a detection circuit is necessary for generating a reset signal to restart the optical drive when a malfunction is detected, thus preventing damage thereto.

### SUMMARY OF THE INVENTION

The present invention provides a circuit for generating a reset signal to restart an optical drive when the optical malfunctions, preventing burnout of an optical pickup unit (OPU) thereof due to overheated coils nearby.

The present invention provides an OPU burnout protection circuit and an optical drive utilizing the same, monitoring power status of an OPU driver of the optical drive to prevent burnout of an OPU when an application specific integrated circuit (ASIC) chip or central processing unit (CPU) chip malfunctions.

The optical drive has a driver integrated circuit (IC) driving a motor and an actuator thereof. One pin of the driver IC is connected with a power source supplying the necessary power to the actuator. In the present invention, a resistor is connected between the power source and the pin of the driver IC, and a protection circuit monitors power at both ends of the resistor. The protection circuit comprises a monitoring impedance, a malfunction detector, and a malfunction identifier.

The monitoring impedance is coupled with a first power source and a power input end of the OPU driver for monitoring the power status thereof when using the first power source. When a malfunction occurs in the first power source, such as high current in the Focus and Track coils shown in FIG. 1, a sudden voltage drop of the first power source causes an obvious voltage difference V_{diff} at the monitoring impedance.

The malfunction detector is coupled with the first power source and the power input end of the OPU driver. When the optical drive and the OPU driver thereof using the first power source malfunction, the malfunction detector detects the voltage difference V_{diff} and outputs a notification signal.

The malfunction identifier receives and processes the notification signal output from the malfunction detector for determining whether the notification signal is temporary, if so, the malfunction identifier stays in standby mode. If not, the malfunction identifier outputs a warning signal to direct the optical drive to execute a specific operation for preventing burnout of the OPU due to overheated coils nearby.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram of a conventional OPU.

FIG. 2 is a block diagram of an optical drive with OPU burnout protection.

FIG. 3 is a block diagram of a protection circuit in detail.

FIG. 4 shows circuits of a malfunction identifier.

FIG. 5 shows circuits of a protection circuit of the present invention.

### DETAILED DESCRIPTION OF THE INVENTION

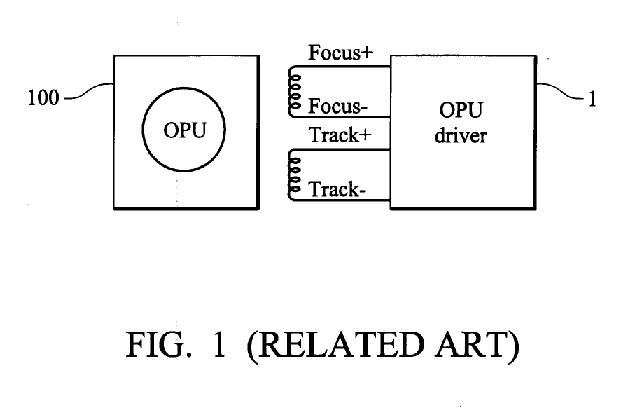

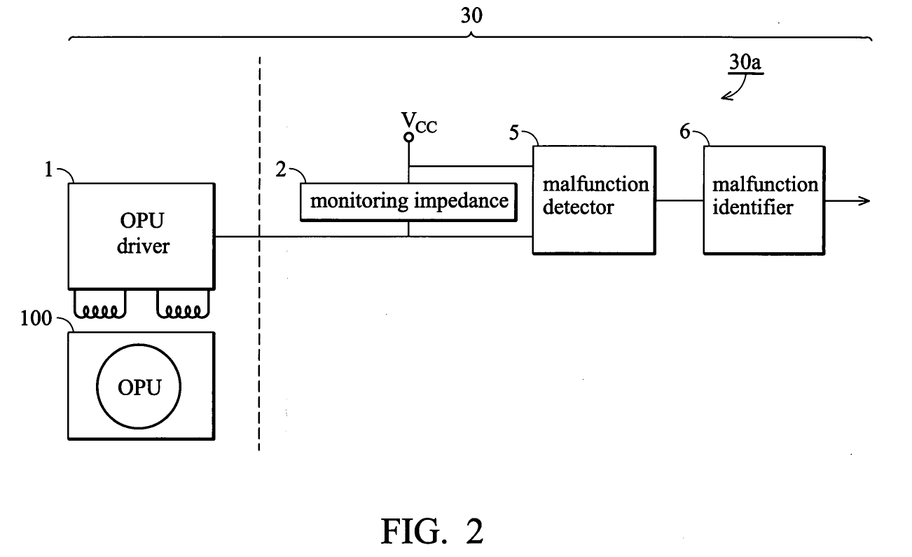

FIG. 2 is a block diagram of an optical drive 30 with OPU burnout protection. The optical pickup unit (OPU) burnout protection optical drive 30 includes an OPU 100, an OPU driver 1, and a protection circuit 30a. The protection circuit 30a includes a monitoring impedance 2, a malfunction detector 5, and a malfunction identifier 6. The monitoring impedance 2 is coupled with a first power source V_{cc} and a power input end of the OPU driver 1. The malfunction detector 5 is coupled with both ends of the monitoring impedance 2. The malfunction identifier 6 is coupled with the malfunction detector 5. The monitoring impedance 2 monitors power status of the OPU driver 1 when the OPU driver 1 uses the first power source V_{cc}. When the OPU driver 1 using the first power source V_{cc} malfunctions due to, for example, high current in the Focus and Track coils shown in FIG. 1, the power input end of the OPU driver 1 gains high current from the first power source VCC, thus causing a voltage difference V_{diff} between two ends of the monitoring impedance 2. When detecting the voltage difference V_{diff}, the malfunction detector 5 outputs a notification signal to the malfunction identifier 6. The malfunction identifier 6 determines whether the notification signal is temporary, if so, the malfunction identifier 6 stays in standby mode. If not, the malfunction identifier 6 outputs a warning signal to direct the OPU burnout protection optical drive 30 to execute a specific operation for preventing burnout of the OPU 100.

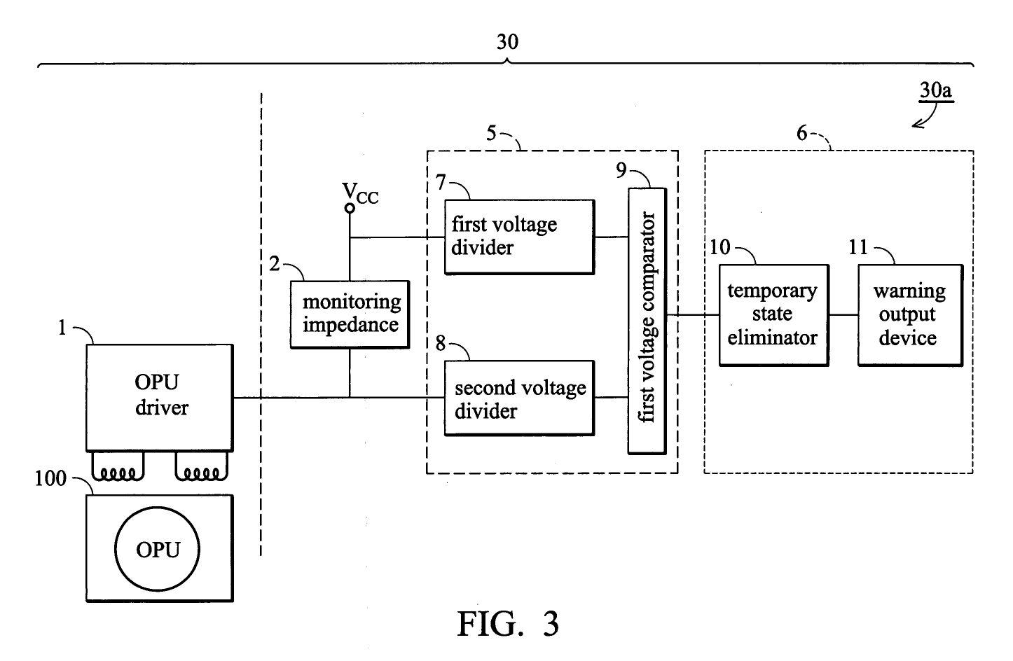

FIG. 3 is a block diagram of the protection circuit 30a in detail. The malfunction detector 5 comprises a first voltage divider 7, a second voltage divider 8, and a first voltage comparator 9. The first and the second voltage dividers 7 and 8 are respectively coupled with two ends of the monitoring impedance 2. The first voltage comparator 9 is coupled with the first and the second voltage dividers 7 and 8. Normally, the first and the second voltage dividers 7 and 8 respectively generate two fixed voltages, a first voltage V1 and a second voltage V2, and the first voltage V1 is less than the second voltage V2. When occurring between two ends of the monitoring impedance 2, the voltage difference V_{diff} causes a drop of the second voltage V2. When the second voltage V2 becomes less than the first voltage V1, the first voltage comparator 9 immediately outputs the notification signal to the malfunction identifier 6.

The malfunction identifier 6 includes a temporary state eliminator 10 and a warning output device 11. The temporary state eliminator 10 is disposed between the first voltage comparator 9 and the warning output device 11. The temporary state eliminator 10 determines whether the notification signal is temporary, if so, the malfunction identifier 6 stays in standby mode. If not, the malfunction identifier 6 outputs the warning signal to direct the optical drive 30 to execute a specific operation, such as restarting the optical drive 30 or the OPU driver 1, to prevent burnout of the OPU 100.

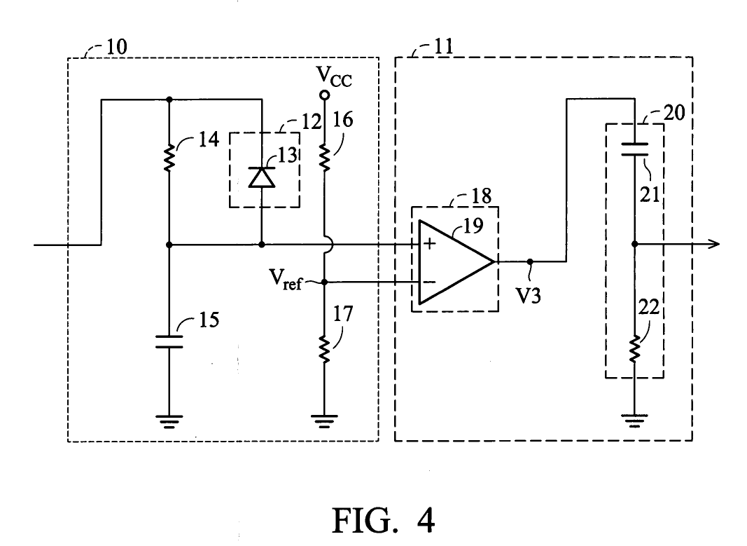

FIG. 4 shows circuits of the malfunction identifier 6. The temporary state eliminator 10 includes a first resistor 14 and a unidirectional conduction device 12 connected in parallel and disposed between the malfunction detector 5 and the warning output device 11. A capacitor 15 is coupled with the first resistor 14. A third resistor 16 and a fourth resistor 17 constitute a voltage dividing circuit and supply a reference voltage V_{ref} to the warning output device 11. The unidirectional conduction device 12 comprises a diode 13. The warning output device 11 includes a second voltage comparator 18 coupled with an output end of the temporary state eliminator 10 and a pulse generator 20. The second voltage comparator 18 comprises a second operational amplifier 19. The pulse generator 20 comprises a second capacitor 21 and a fifth resistor 22. When the temporary state eliminator 10 receives the notification signal, an output voltage V3 of the second operational amplifier 19 does not increase rapidly, due to the integrator comprising the first resistor 14 and the capacitor 15. In addition, because the integrator is connected in parallel with the diode 13, the integrator has a low charge rate and a high discharge rate. If the malfunction detector 5 continuously outputs high voltage for a considerable period, voltage of the capacitor 15 is charged to exceed the reference voltage V_{ref}, and thus the output voltage V3 of the second operational amplifier 19 becomes high voltage. The period is adjusted by setting various values of the first resistor 14 and the capacitor 15. When the output voltage V3 of the second operational amplifier 19 is high, the pulse generator 20 outputs the warning signal having a single pulse. The warning signal drives the OPU burnout protection optical drive 30 to execute a specific operation preventing burnout of the OPU 100 due to overheated coils near the OPU.

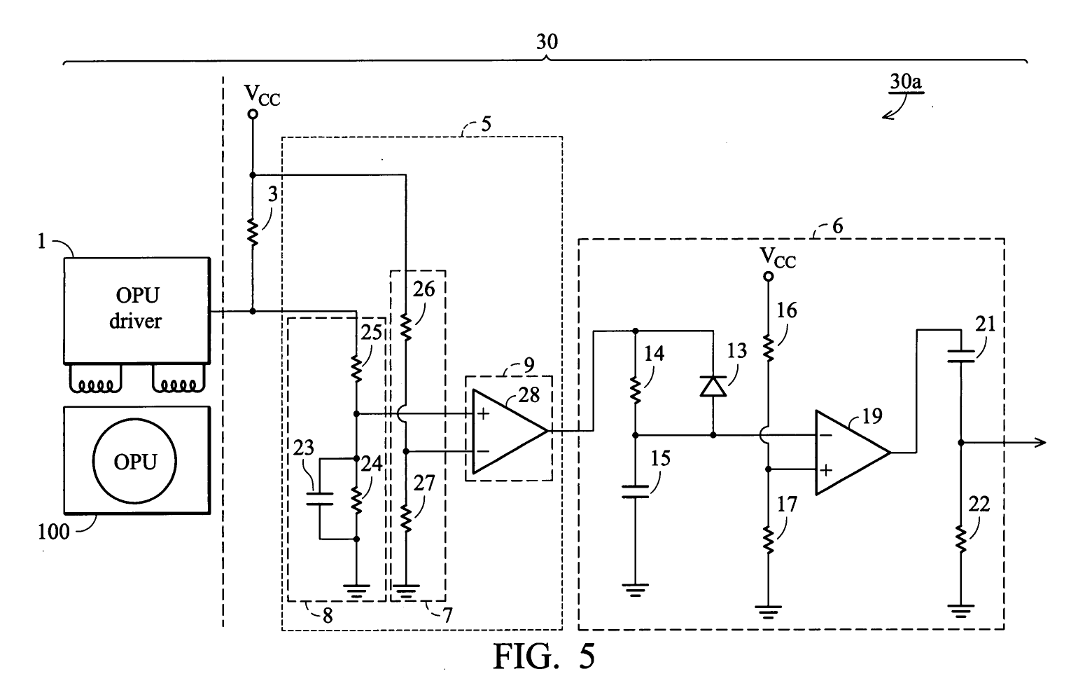

FIG. 5 shows circuits of the protection circuit 30a of the present invention. The monitoring impedance 2 comprises a monitoring resistor 3 having a relatively small value, such as 0.5 Ω. The first voltage divider 7 comprises an eighth resistor 26 and a ninth resistor 27. The second voltage divider 8 comprises a third capacitor 23, a sixth resistor 24, and a seventh resistor 25. The first voltage comparator 9 is a first operational amplifier 28.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical pickup unit (OPU) burnout protection circuit, comprising:
a monitoring impedance coupled with a first power source and a power input end of an OPU driver of an optical drive and monitoring power status of the OPU driver when the OPU driver uses the first power source;
a malfunction detector coupled with the first power source and the power input end of the OPU driver and outputting a notification signal when the optical drive and the OPU driver thereof using the first power source malfunction; and
a malfunction identifier receiving and processing the notification signal output from the malfunction detector, when the notification signal is temporary, the malfunction identifier stays in standby mode, if not, a warning signal directing the optical drive to execute a specific operation preventing burnout of an OPU is output.

2. The OPU burnout protection circuit as claimed in claim 1, wherein the malfunction identifier comprises:
a temporary state eliminator coupled with an output end of the malfunction detector, wherein a discharge rate of the temporary state eliminator is greater than a charge rate of the temporary state eliminator, and an output of the temporary state eliminator cannot be charged to exceed a reference voltage if the notification signal is temporary, thereby identifying malfunction; and
a warning output device coupled with an output end of the temporary state eliminator generating the warning signal when the output of the temporary state eliminator exceeds the reference voltage.

3. The OPU burnout protection circuit as claimed in claim 1, wherein the malfunction detector comprises:
a first and a second voltage divider respectively coupled with the first power source and the power input end of the OPU driver; and
a first voltage comparator coupled with the first and the second voltage dividers generating the notification signal when voltage of the first power source differs from voltage of the power input end of the OPU driver due to malfunction of the optical drive and the OPU driver thereof using the first power source.

4. The OPU burnout protection circuit as claimed in claim 2, wherein the temporary state eliminator comprises:
a capacitor coupled between an input end of the warning output device and a reference voltage node;
a first resistor coupled between the output end of the malfunction detector and the input end of the warning output device providing a charge path through which the notification signal charges the capacitor; and
a unidirectional conduction device connected in parallel with the first resistor providing a discharge path through which the capacitor discharges the output end of the malfunction detector, wherein internal resistance of the unidirectional conduction device is less than resistance of the first resistor, thereby the discharge rate of the temporary state eliminator is greater than the charge rate of the temporary state eliminator.

5. The OPU burnout protection circuit as claimed in claim 2, wherein the warning output device comprises:
a second voltage comparator coupled with the reference voltage and the output end of the temporary state eliminator comparing the reference voltage with voltage of the output end of the temporary state eliminator, wherein when voltage of the output end of the temporary state eliminator is greater than the reference voltage, the second voltage comparator outputs a processing signal; and
a pulse generator coupled with the second voltage comparator outputting the warning signal having a single pulse when receiving the processing signal output from the second voltage comparator.

6. The OPU burnout protection circuit as claimed in claim 3, wherein the malfunction detector is a first operational amplifier.

7. The OPU burnout protection circuit as claimed in claim 5, wherein the alarm output device is a second operational amplifier.

8. The OPU burnout protection circuit as claimed in claim 5, wherein the pulse generator is a differential circuit.

9. The OPU burnout protection circuit as claimed in claim 8, wherein the differential circuit is a differentiator comprising a capacitor and a resistor.

10. The OPU burnout protection circuit as claimed in claim 4, wherein the unidirectional conduction device is a diode.

11. A optical drive with optical pickup unit (OPU) burnout protection, comprising:
an OPU accessing data on a compact disc (CD);
an OPU driver driving the OPU;
a monitoring impedance coupled with a first power source and a power input end of the OPU driver and monitoring power status of the OPU driver when the OPU driver uses the first power source;
a malfunction detector coupled with the first power source and the power input end of the OPU driver and outputting a notification signal when the optical drive and the OPU driver thereof using the first power source malfunction; and
a malfunction identifier receiving and processing the notification signal output from the malfunction detector, when the notification signal is temporary, the malfunction identifier stays in standby mode, if not, a warning signal directing the optical drive to execute a specific operation preventing burnout of the OPU is output.

12. The optical drive as claimed in claim 11, wherein the malfunction identifier comprises:
a temporary state eliminator coupled with an output end of the malfunction detector, wherein a discharge rate of the temporary state eliminator is greater than a charge rate of the temporary state eliminator, and an output of the temporary state eliminator cannot be charged to exceed a reference voltage if the notification signal is temporary, thereby identifying malfunction; and
a warning output device coupled with an output end of the temporary state eliminator generating the warning signal when the output of the temporary state eliminator exceeds the reference voltage.

13. The optical drive as claimed in claim 11, wherein the malfunction detector comprises:
a first and a second voltage divider respectively coupled with the first power source and the power input end of the OPU driver; and
a first voltage comparator coupled with the first and the second voltage dividers generating the notification signal when voltage of the first power source differs from voltage of the power input end of the OPU driver due to malfunction of the optical drive and the OPU driver thereof using the first power source.

14. The optical drive as claimed in claim 12, wherein the temporary state eliminator comprises:
a capacitor coupled between an input end of the warning output device and a reference voltage node;
a first resistor coupled between the output end of the malfunction detector and the input end of the warning output device providing a charge path through which the notification signal charges the capacitor; and
a unidirectional conduction device connected in parallel with the first resistor providing a discharge path through which the capacitor discharges the output end of the malfunction detector, wherein internal resistance of the unidirectional conduction device is less than resistance of the first resistor, thereby the discharge rate of the temporary state eliminator is greater than the charge rate of the temporary state eliminator.

15. The optical drive as claimed in claim 12, wherein the warning output device comprises:
a second voltage comparator coupled with the reference voltage and the output end of the temporary state eliminator comparing the reference voltage with voltage of the output end of the temporary state eliminator, wherein when voltage of the output end of the temporary state eliminator is greater than the reference voltage, the second voltage comparator outputs a processing signal; and
a pulse generator coupled with the second voltage comparator outputting the warning signal having a single pulse when receiving the processing signal output from the second voltage comparator.

16. The optical drive as claimed in claim 13, wherein the first voltage comparator is a first operational amplifier.

17. The optical drive as claimed in claim 15, wherein the second voltage comparator is a second operational amplifier.

18. The optical drive as claimed in claim 15, wherein the pulse generator is a differential circuit.

19. The optical drive as claimed in claim 18, wherein the differential circuit is a differentiator comprising a capacitor and a resistor.

20. The optical drive as claimed in claim 14, wherein the unidirectional conduction device is a diode.
